(19) United States
(12) Patent Application Publication
(10) Pub. No.: US 2026/0124820 A1
(43) Pub. Date: May 7, 2026

(54) REINFORCED MAGNESIUM SUBSTRATE AND COMPOSITE BOARD WITH SAME

(71) Applicant: Oakland Global Trading Co.,Ltd., Changzhou (CN)

(72) Inventor: Biao WANG, Changzhou (CN)

(73) Assignee: Oakland Global Trading Co.,Ltd., Changzhou (CN)

(21) Appl. No.: 18/983,332

(22) Filed: Dec. 16, 2024

(30) Foreign Application Priority Data
Nov. 6, 2024 (CN) 202411572786.4

(51) Int. Cl. B32B 9/04; B32B 7/12; B32B 9/00; B32B 21/06; B32B 21/14

(52) U.S. Cl. CPC B32B 9/042; B32B 7/12; B32B 9/005; B32B 21/06; B32B 21/14; C04B 9/04; C04B 18/26; C04B 22/141; C04B 22/147; C04B 24/06; C04B 28/105; B32B 2250/04; B32B 2250/05; B32B 2262/067; B32B 2607/00; C04B 2111/60

(57) ABSTRACT

Disclosed are a reinforced magnesium substrate and a composite board with the same. The reinforced magnesium substrate includes the following components in parts by weight: 240-280 parts of magnesium oxide, 172-192 parts of wood fiber, 1.3-3.5 parts of citric acid, 1.3-3.5 parts of phosphoric acid, 1.3-3.5 parts of sodium sulfate, 90-120 parts of magnesium sulfate and 109-130 parts of water. The composite board with the reinforced magnesium substrate includes the reinforced magnesium substrate, wood board layers and a wear-resistant layer. The reinforced magnesium substrate is configured as a board core of the composite board; the wood board layers are arranged on the two sides of the reinforced magnesium substrate respectively; and the wear-resistant layer is arranged on at least one wood board layer and relatively fixed with the wood board layer.

### CROSS-REFERENCE TO RELATED APPLICATIONS

This application claims priority to Chinese Patent Application No. 202411572786.4, filed on Nov. 6, 2024, the content of which is incorporated herein by reference in its entirety.

### TECHNICAL FIELD

The present application relates to the field of building panels, and in particular to a reinforced magnesium substrate and a composite board with the reinforced magnesium substrate.

### BACKGROUND

In the field of building panels, boards laid on the ground or walls typically have the characteristics such as waterproofness, moisture resistance, low cost, and resistance to deformation, etc. In this regard, laminated flooring with fiberboard or granular board, or hard materials such as tiles and stone are mostly used in the market. Depending on the different needs of users, wooden boards, plastic boards, and hard boards are chosen to be laid on the floor or wall.

When users use hard materials such as tiles and stone, although the materials themselves have the characteristics of beautifying objects, being easy to wipe and clean, and not being eroded by dust and dirt, due to their high hardness and poor toughness, they can withstand less external deformation. If tiles and stone are subjected to external stress, they will crack or break, therefore, when installing tiles and stone on walls or the floors, manual laying and bonding with adhesives, cement, etc. are usually used. Moreover, there is no additional structure for mutual fixation on the body of tiles and stone after or during cutting.

Some users use common glass magnesium flat panels to replace tiles and stone, glass magnesium flat panels, also known as fireproof composite panels or magnesium oxide panels, are stable performance magnesium based cementitious materials made from a ternary system of magnesium oxide, magnesium chloride, and water, configured and modified with additives. Although glass magnesium flat panels are good in fireproofing, strength, waterproofness and moisture resistance, they will undergo significant deformation when exposed to dark and humid environments for a long time, which will affect the stability of decoration; In addition, the maintenance period of glass magnesium flat panels is relatively long, and the early strength is low.

### SUMMARY

According to various embodiments of the present application, a reinforced magnesium substrate and a composite board with the same are provided.

To achieve the above object, the present application provides the following technical solutions.

The reinforced magnesium substrate comprises the following components in parts by weight: 240-280 parts of magnesium oxide, 172-192 parts of wood fiber, 1.3-3.5 parts of citric acid, 1.3-3.5 parts of phosphoric acid, 1.3-3.5 parts of sodium sulfate, 90-120 parts of magnesium sulfate and 109-130 parts of water.

Optionally, a weight ratio of citric acid to phosphoric acid to sodium sulfate is 1:1:1.

Optionally, the magnesium oxide is 255-265 parts by weight; the magnesium sulfate is 100-110 parts by weight; and the water is 115-125 parts by weight.

Optionally, the fiber length of the wood fiber is 3-6 mm, and the moisture content of the wood fiber is 0.5%-10%.

Optionally, the magnesium oxide is light burned magnesium oxide, and the magnesium sulfate is anhydrous magnesium sulfate.

A composite board with the reinforced magnesium substrate according to the above solution, comprising:
a reinforced magnesium substrate configured as a plate core of the composite board;
wood board layers arranged on two sides of the reinforced magnesium substrate respectively and fixed relative to the reinforced magnesium substrate;
a wear-resistant layer arranged on at least one wood board layer and relatively fixed with the wood board layer.

Optionally, the composite board further includes a connecting layer, the connecting layer is between the wood board layer and the reinforced magnesium substrate, and the connecting layer is made of polyurethane adhesive.

Optionally, the composite board further includes a decorative paper, and the decorative paper is between the wood board layer and the wear-resistant layer.

Optionally, the composite board further includes a balance paper, the balance paper is on the wood board layer located on an inner side of the reinforced magnesium substrate, and the balance paper faces the ground or wall on which the composite board is laid.

Optionally, the composite board further includes a cushion layer, and the cushion layer is in contact with the ground or wall on which the composite board is laid.

Details of one or more embodiments of the present application are set forth in the following figures and description. Features, objects, and advantages of the present application will become apparent from the specification, drawings, and claims.

### BRIEF DESCRIPTION OF THE DRAWINGS

FIG. 1 is a structural diagram of a composite board according to an embodiment of the present application.

FIG. 2 is a structural diagram of a composite board according to another embodiment of the present application.

FIG. 3 is a structural diagram of a composite board according to another embodiment of the present application.

FIG. 4 is a structural diagram of a composite board according to another embodiment of the present application.

FIG. 5 is a structural diagram of a composite board according to another embodiment of the present application.

### DETAILED DESCRIPTION OF THE EMBODIMENTS

The technical solutions in the embodiments of the present application will be clearly and completely described below with reference to the accompanying drawings in the embodiments and obviously, the described embodiments are only a part of the embodiments of the present application, but not all the embodiments. Based on the embodiments of the present application, all other embodiments obtained by those skilled in the art without creative efforts fall within the protection scope of the present application.

The terminology used in this disclosure is for the purpose of describing particular embodiments only and is not intended to limit this disclosure. As used in this disclosure and the appended claims, the singular forms “a” “the” and “the” are also intended to include plural forms unless the context clearly indicates other meanings. It should also be understood that the term “and/or” as used herein refers to and encompasses any or all possible combinations of one or more associated listed items.

In the description of the present application, it should be understood that the orientation or position relationship indicated by the terms “longitudinal”, “transverse”, “upper”, “front”, “rear”, “left”, “right”, “vertical”, “horizontal”, “top”, “bottom”, “inner”, “outer” and the like is based on the orientation or position relationship shown in the drawings, and is only for the convenience of describing the present application and simplifying the description, rather than indicating or implying that the indicated device or element must have a specific orientation, be constructed and operated in a specific orientation, and therefore cannot be understood as a limitation on the present application.

The application relates to a reinforced magnesium substrate which comprises the following components in parts by weight: 240-280 parts of magnesium oxide, 172-192 parts of wood fiber, 1.3-3.5 parts of citric acid, 1.3-3.5 parts of phosphoric acid, 1.3-3.5 parts of sodium sulfate, 90-120 parts of magnesium sulfate and 109-130 parts of water.

In one embodiment, the magnesium oxide is light burned magnesium oxide, the light burned magnesium oxide has a content of magnesium oxide of ≥85%, and a content of active magnesium content of >65%. Optionally, the magnesium oxide is 255-265 parts by weight.

If the ratio of magnesium oxide to magnesium sulfate is continuously increased, the amount of mixing water is increased, the concentration of magnesium sulfate is reduced, the water bleeding phenomenon may occur when the material is formed, the coagulation efficiency is affected, and it is difficult to ensure good early strength; if the ratio of magnesium oxide to magnesium sulfate is reduced, although the concentration of magnesium sulfate is ensured, the cementitious material has the problems of low mechanical property and poor water resistance after being formed, and it is difficult to meet the design requirements. If the amount of water is increased relative to the sum of the mass of magnesium oxide and magnesium sulfate, the concentration of magnesium sulfate will be reduced, and the problem of bleeding still exists; if the amount of water is reduced, the mixture is incompletely hydrated, the cementitious material is not easy to form, and the mechanical property of the material is affected. Therefore, in the present embodiment, by controlling the ratio of magnesium oxide, magnesium sulfate and water, the amount of water may be reduced on the basis of ensuring complete hydration of the mixture, avoiding the water bleeding phenomenon from affecting the condensation of the material, so that the cementitious material has good early strength after molding.

In one embodiment, the length of the wood fiber is 3-6 mm, and the moisture content of the wood fiber is 0.5%-10%. Optionally, the wood fiber is 175-185 parts by weight. The wood fiber may further improve the dispersity of the cementitious material, so that the cementitious material is uniformly mixed with other components, meanwhile, the weight of the board may be reduced, and the structural strength is improved.

In one embodiment, the citric acid is 2-3 parts by weight.

In one embodiment, the phosphoric acid is 2-3 parts by weight.

In one embodiment, the sodium sulfate is 2-3 parts by weight.

In one embodiment, the weight ratio of citric acid, phosphoric acid and sodium sulfate is 1:1:1. Citric acid, phosphoric acid and sodium sulfate cooperate to achieve uniform and rapid hardening of the material. By adopting the specific ratio of citric acid, phosphoric acid and sodium sulfate, the hydration reaction may be promoted, the condensation and hardening process is accelerated, the early strength of the material is improved, meanwhile, the PH value and the electric potential of the mixture are controlled, the uniform distribution of the cementitious material is ensured, and then uniform and rapid hardening is achieved.

In one embodiment, the magnesium sulfate is anhydrous magnesium sulfate. Optionally, the magnesium sulfate is 100-110 parts by weight. Sodium sulfate may increase the swelling property between the wood fibers, thereby increasing the toughness of the wood fibers, and further improving the mechanical properties of the material. In one embodiment, the water is 115-125 parts by weight.

The present application relates to a preparation method for of the reinforced magnesium substrate, comprising the following steps:
A1, fully stirring the components in a stirrer at room temperature to obtain a mixed slurry;
A2, pouring the mixed slurry into a mold for curing at a temperature of 20° C.-30° C., and a humidity of 40%-60%, and curing for 7 days to obtain a reinforced magnesium substrate.

This application is described by using the following examples, but is not limited thereto.

### Raw Material Selection

The magnesium oxide is light burned magnesium oxide, the light burned magnesium oxide has a content of magnesium oxide of ≥85%, and a content of active magnesium content of >65%.

The wood fiber has a length of 5 mm and a moisture content of 0.5%-10%.

Citric acid has a purity of 99%.

Phosphoric acid is industrial-grade 85% phosphoric acid.

The purity of sodium sulfate is 99%.

The magnesium sulfate is anhydrous magnesium sulfate.

### Preparation Method

A1, fully stirring the components in a stirrer at room temperature to obtain a mixed slurry;
A2, pouring the mixed slurry into a mold for curing at a curing temperature of 25° C. and a humidity of 50%, and curing for 7 days to obtain a reinforced magnesium substrate.

### Embodiment 1

First, 260 parts of magnesium oxide, 180 parts of wood fiber, 2.38 parts of citric acid, 2.38 parts of phosphoric acid, 2.38 parts of sodium sulfate, 108 parts of magnesium sulfate, and 120 parts of water were fully stirred in a stirrer to obtain a mixed slurry; then the mixed slurry was poured into a mold for curing at a curing temperature of 25° C. and a humidity of 50% for 7 days to obtain an experimental sample 1.

### Embodiment 2

First, 245 parts of magnesium oxide, 175 parts of wood fiber, 2 parts of citric acid, 2 parts of phosphoric acid, 2 parts of sodium sulfate, 100 parts of magnesium sulfate, and 110 parts of water were fully stirred in a stirrer to obtain a mixed slurry; then the mixed slurry was poured into a mold for curing at a curing temperature of 25° C. and a humidity of 50% for 7 days to obtain an experimental sample 2.

### Embodiment 3

First, 275 parts of magnesium oxide, 185 parts of wood fiber, 3 parts of citric acid, 3 parts of phosphoric acid, 3 parts of sodium sulfate, 115 parts of magnesium sulfate, and 130 parts of water were fully stirred in a stirrer to obtain a mixed slurry; then the mixed slurry was poured into a mold for curing at a curing temperature of 25° C. and a humidity of 50% for 7 days to obtain an experimental sample 3.

### Embodiment 4

First, 260 parts of magnesium oxide, 180 parts of wood fiber, 2.38 parts of citric acid, 2.38 parts of phosphoric acid, 2.38 parts of sodium sulfate, 95 parts of magnesium sulfate, and 110 parts of water were fully stirred in a stirrer to obtain a mixed slurry; then the mixed slurry was poured into a mold for curing at a curing temperature of 25° C. and a humidity of 50% for 7 days to obtain an experimental sample 4.

### Embodiment 5

First, 260 parts of magnesium oxide, 180 parts of wood fiber, 2.38 parts of citric acid, 2.38 parts of phosphoric acid, 2.38 parts of sodium sulfate, 118 parts of magnesium sulfate, and 125 parts of water were fully stirred in a stirrer to obtain a mixed slurry; then the mixed slurry was poured into a mold for curing, the curing temperature was 25° C., the humidity was 50%, and after curing for 7 days, an experimental sample 5 was obtained.

### Embodiment 6

First, 260 parts of magnesium oxide, 180 parts of wood fiber, 1.5 parts of citric acid, 3.5 parts of phosphoric acid, 2.5 parts of sodium sulfate, 108 parts of magnesium sulfate, and 120 parts of water were fully stirred in a stirrer to obtain a mixed slurry; then the mixed slurry was poured into a mold for curing at a curing temperature of 25° C. and a humidity of 50% for 7 days to obtain an experimental sample 6.

### Embodiment 7

First, 260 parts of magnesium oxide, 180 parts of wood fiber, 3.5 parts of citric acid, 1.5 parts of phosphoric acid, 2.5 parts of sodium sulfate, 108 parts of magnesium sulfate, and 120 parts of water were fully stirred in a stirrer to obtain a mixed slurry; then the mixed slurry was poured into a mold for curing, the curing temperature was 25° C., the humidity was 50%, and after 7 days of curing, an experimental sample 7 was obtained.

### Comparative Embodiment 1

First, 260 parts of magnesium oxide, 180 parts of wood fiber, 2.38 parts of citric acid, 2.38 parts of sodium sulfate, 108 parts of magnesium sulfate, and 120 parts of water were fully stirred in a stirrer to obtain a mixed slurry; then the mixed slurry was poured into a mold for curing, the curing temperature was 25° C., the humidity was 50%, and after curing for 7 days, a comparative sample 1 was obtained.

### Comparative Embodiment 2

First, 260 parts of magnesium oxide, 180 parts of wood fiber, 2.38 parts of citric acid, 2.38 parts of phosphoric acid, 108 parts of magnesium sulfate, and 120 parts of water were fully stirred in a stirrer to obtain a mixed slurry; then the mixed slurry was poured into a mold for curing, the curing temperature was 25° C., the humidity was 50%, and after curing for 7 days, a comparative sample 2 was obtained.

### Comparative Embodiment 3

First, 260 parts of magnesium oxide, 180 parts of wood fiber, 2.38 parts of citric acid, 108 parts of magnesium sulfate, and 120 parts of water were fully stirred in a stirrer to obtain a mixed slurry; then the mixed slurry was poured into a mold for curing, the curing temperature was 25° C., the humidity was 50%, and after curing for 7 days, a comparative sample 3 was obtained.

The components and formulations in various Embodiments 1-7 are shown in Table 1; The components and formulations in various Comparative Embodiments 1-3 is shown in Table 2.

TABLE 1

| | Embodiment | Embodiment | Embodiment | Embodiment | Embodiment | Embodiment | Embodiment |
|---|---|---|---|---|---|---|---|
| Components | 1 | 2 | 3 | 4 | 5 | 6 | 7 |
| Magnesium | 260 | 245 | 275 | 260 | 260 | 260 | 260 |
| Oxide | | | | | | | |
| Wood | 180 | 175 | 185 | 180 | 180 | 180 | 180 |
| fiber | | | | | | | |
| Citric | 2.38 | 2 | 3 | 2.38 | 2.38 | 1.5 | 3.5 |
| Acid | | | | | | | |
| Phosphoric | 2.38 | 2 | 3 | 2.38 | 2.38 | 3.5 | 1.5 |
| Acid | | | | | | | |
| Sodium | 2.38 | 2 | 3 | 2.38 | 2.38 | 2.5 | 2.5 |
| Sulfate | | | | | | | |
| Magnesium | 108 | 100 | 115 | 95 | 118 | 108 | 108 |
| sulfate | | | | | | | |
| Water | 120 | 110 | 130 | 110 | 125 | 120 | 120 |

TABLE 2

| | Comparative | Comparative | Comparative |
|---|---|---|---|
| Components | Embodiment 1 | Embodiment 2 | Embodiment 3 |
| Magnesium | 260 | 260 | 260 |
| Oxide | | | |
| Wood fiber | 180 | 180 | 180 |
| Citric Acid | 2.38 | 2.38 | 2.38 |
| Phosphoric Acid | / | 2.38 | / |
| Sodium Sulfate | 2.38 | / | / |
| Magnesium | 108 | 108 | 108 |
| sulfate | | | |
| Water | 120 | 120 | 120 |

The prepared experimental samples 1-7 and comparative samples 1-3 were tested by the following method, and the performance test results of each sample were shown in Table 3.

Compressive strength: tested according to JC688-2006 “Glass fiber & magnesium cement board”.

Impact strength: tests were carried out referring to an impact strength determination method in GB/T1043.1, “Plastics-Determination of Charpy impact properties-Part 1: Non-instrumental impact test”.

Dehalogenation resistance: Referring to JC688-2006 Glass fiber & magnesium cement board”, 200 mm*200 mm plates were randomly cut from each of 3 plates of a group of samples, placed in a constant-temperature and constant-humidity box with a relative humidity of greater than or equal to 90% and a temperature of 30° C.-35° C., and taken out after 24 h, and observe whether there are water drops or get damp.

TABLE 3

| Detecting Items | | | | | |
|---|---|---|---|---|---|
| Bending Strength/ | | Impact Strength/ | | | |
| MPa | | kJ/ | | Dehalogenation | |
| Time | | | | | |
| 1 day | 14 days | 1 day | 14 days | 1 day | 14 days |

| | | | | | |
|---|---|---|---|---|---|
| Embodiment 1 | 34 | 36 | 23 | 25 | No water drops, |
| | | | | | no damping |
| Embodiment 2 | 32 | 34 | 20 | 23 | No water drops, |
| | | | | | no damping |
| Embodiment 3 | 33 | 35 | 22 | 24 | No water drops, |
| | | | | | no damping |
| Embodiment 4 | 30 | 32 | 19 | 22 | No water drops, |
| | | | | | no damping |
| Embodiment 5 | 31 | 33 | 20 | 22 | No water drops, |
| | | | | | no damping |
| Embodiment 6 | 29 | 32 | 18 | 21 | No water drops, |
| | | | | | no damping |
| Embodiment 7 | 28 | 32 | 19 | 20 | No water drops, |
| | | | | | no damping |
| Comparative | 20 | 28 | 14 | 18 | No water drops, |
| Embodiment 1 | | | | | no damping |
| Comparative | 19 | 26 | 14 | 17 | No water drops, |
| Embodiment 2 | | | | | no damping |
| Comparative | 17 | 26 | 12 | 16 | No water drops, |
| Embodiment 3 | | | | | no damping |

Through comparison between the examples and the comparative examples, it shows that the experimental samples 1-7 has significantly improved bending strength and impact strength, and the early strength after 7 days of maintenance is higher, which is close to the strength of continuous maintenance for 14 days.

Continue to perform dry shrinkage test on the experimental samples 1-7 and the comparative samples 1-3, the test method is as follows: measuring the initial size of the board, placing the board in a drying oven at 60° C., keeping the temperature constant, taking out after 6 hours, respectively recording the sizes of the dried board after continuous drying for 6 days and 10 days, and calculating the dry shrinkage rate according to the following formula: dry shrinkage

$$rate = ( \frac{( {L}_{1} - {L}_{0} ) + ( {W}_{1} - {W}_{0 )}}{{L}_{0} + {W}_{0}} ) \times 100 \% ;$$

Wherein, L₁ is the length after dry shrinkage; L₀ is the initial length; is the width after dry shrinkage; W₀ is the initial length.

Test results of embodiments 1-7 are shown in Table 4; test results of comparative embodiments 1-3 are shown in Table 5.

TABLE 4

| | Detecting Items | |
|---|---|---|
| | 60 degrees Celsius/6 hours dry shrinkage | |
| | Time | |
| | 1 days | 10 days |
| Experimental Embodiment 1 | −0.02% | −0.08% |
| Experimental Embodiment 2 | −0.03% | −0.09% |
| Experimental Embodiment 3 | −0.03% | −0.08% |
| Experimental Embodiment 4 | −0.03% | −0.10% |
| Experimental Embodiment 5 | −0.03% | −0.09% |
| Experimental Embodiment 6 | −0.03% | −0.10% |
| Experimental Embodiment 7 | −0.04% | −0.10% |

TABLE 5

| | Detecting Items | |
|---|---|---|
| | 60 degrees Celsius/6 hours dry shrinkage | |
| | Time | |
| | 1 day | 10 days |
| Comparative Embodiment 1 | −0.05% | −0.13% |
| Comparative Embodiment 2 | −0.07% | −0.14% |
| Comparative Embodiment 3 | −0.60% | −0.14% |

It may be seen from the measurement results of Table 4 and Table 5 that the experimental samples 1-7 has excellent dry shrinkage resistance at high temperature, and still maintains good shrinkage resistance under a long-term test of 10 days.

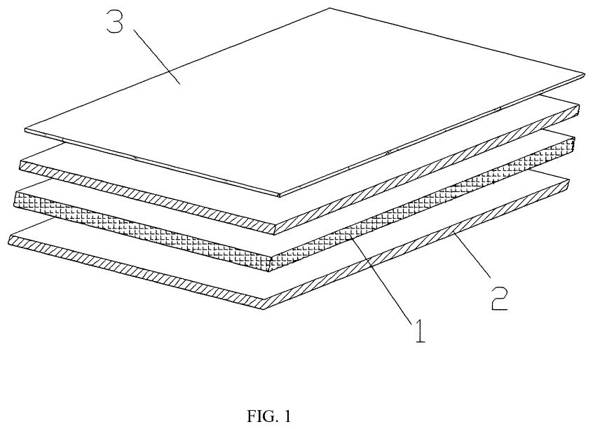

The present application also relates to a composite board with the reinforced magnesium substrate, with reference to FIG. 1, comprising a reinforced magnesium substrate 1, wood board layers 2 and a wear-resistant layer 3. The reinforced magnesium substrate 1 is configured as a plate core of the composite board and is arranged in the middle part of the composite board; the wood board layers 2 are arranged on the two sides of the reinforced magnesium substrate 1 respectively and are fixed on the reinforced magnesium substrate 1 through an adhesive or other means; and the wear-resistant layer 3 is arranged on at least one wood board layer 2 and is fixedly connected with the wood board layer 2 through an adhesive or other means, Optionally, the wear-resistant layer 3 is arranged on the wood board layer 2 located on the outside of the reinforced magnesium substrate 1 and faces the far end of the ground or wall where the composite board is laid.

By arranging the wood board layers 2 on two sides of the reinforced magnesium substrate 1, the humidity expansion or contraction of the reinforced magnesium substrate 1 may be reduced, the stability of the composite board is improved, meanwhile, the overall strength and rigidity are increased. The wood board layer 2 may be a solid wood board made of wood logs, or a solid wood particle board and other wood materials. Optionally, the wood board layer 2 is a fireproof board with a thickness not less than 0.5 mm.

Optionally, the reinforced magnesium substrate 1, the wood board layer 2 and the wear-resistant layer 3 have the same size, and the reinforced magnesium substrate 1, the wood board layer 2 and the wear-resistant layer 3 are all arranged in a rectangular shape.

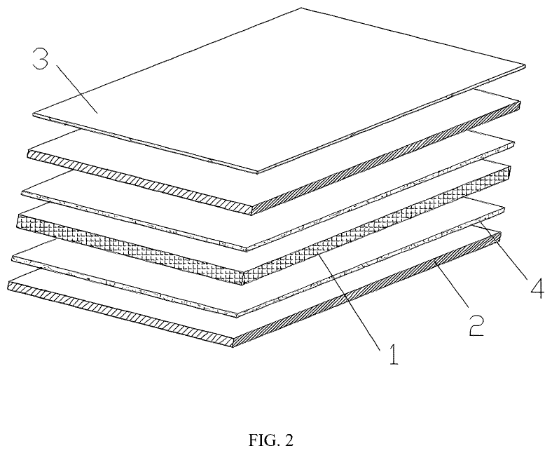

In an embodiment, with reference to FIG. 2, the wood board layer 2 is bonded onto the reinforced magnesium substrate 1, and a connecting layer 4 is set between the wood board layer 2 and the reinforced magnesium substrate 1 to achieve stable connection. Optionally, the connecting layer 4 is made of a polyurethane adhesive. The wood board layer 2 and the reinforced magnesium substrate 1 are connected by a polyurethane adhesive and are formed by low-temperature cold pressing. Optionally, the connection layer 4 covers a side surface of the reinforced magnesium substrate 1.

In an embodiment, the wear-resistant layer 3 is prepared from aluminum oxide surface paper impregnated with melamine resin, and other wear-resistant materials may also be used. When the wear-resistant layer 3 is directly connected to the wood board layer 2, the wear-resistant layer 3 may be formed by pressing at a high temperature, or may be formed by cold pressing at a low temperature through an adhesive.

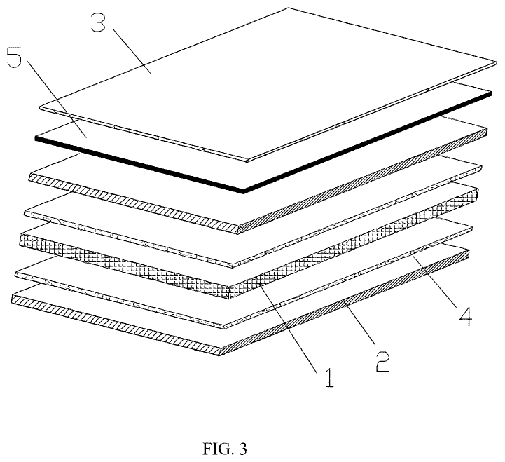

In an embodiment, with reference to FIG. 3, a decorative paper 5 is provided between the wood board layer 2 and the wear-resistant layer 3, and the decorative paper 5 and the wear-resistant layer 3 cooperate with each other to improve the wear resistance of the surface of the composite board, reduce scratches and wear, and effectively improve the moisture resistance of the composite board. A layer of titanium dioxide-containing ink is coated on the surface of the decorative paper 5, and then a melamine-containing resin is coated to improve the scratch resistance. Optionally, the decorative paper 5 covers a side surface of the wood board layer 2.

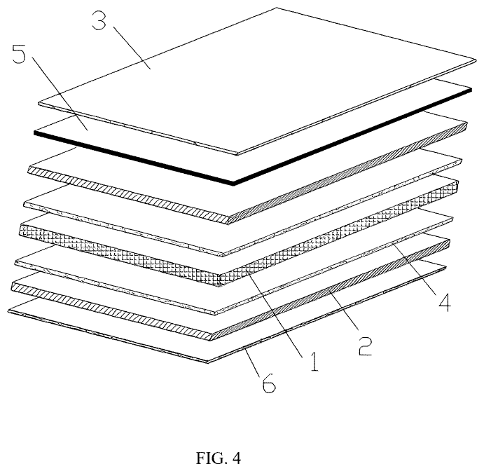

In an embodiment, with reference to FIG. 4, a balance paper 6 is provided on the wood board layer 2 on the inner side of the reinforced magnesium substrate 1, and the balance paper 6 faces the ground or wall on which the composite board is laid. The balance paper 6 may balance the plate stress, stabilize the floor, prevent warping deformation, and ensure the flatness of the floor, and in addition, may effectively prevent moisture from penetrating from the back surface, thereby improving the moisture resistance of the composite board. The balance paper 6 may be a base paper impregnated with melamine resin, and is pressed and attached to the bottom layer of the composite board after high-temperature and high-pressure treatment. Optionally, the balance paper 6 covers the side of the wood board layer 2.

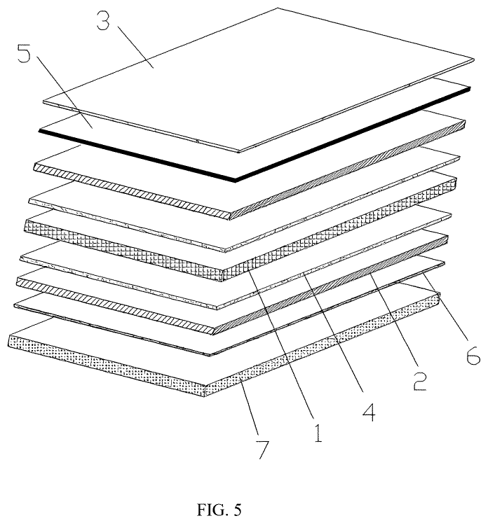

In an embodiment, with reference to FIG. 5, the composite board further includes a cushion layer 7, the cushion layer 7 is an IXPE or EVA cushion layer 7, and the cushion layer 7 is in contact with the ground or wall on which the composite board is laid, to improve buffering, heat insulation, and moisture resistance of the composite board. The cushion layer 7 is connected with the wood board layer 2 through an adhesive or other means, and when the balance paper 6 is arranged on the wood board layer 2 located on the inner side of the reinforced magnesium substrate 1, the cushion layer 7 is directly connected with the balance paper 6.

The present application further relates to a preparation method of a composite board with the reinforced magnesium substrate, specifically including the following steps:
B1, taking a reinforced magnesium substrate 1 as a plate core of the composite board;
B2, laying a wood board layer 2 on both sides of the reinforced magnesium substrate 1;
B3, sequentially laying a wear-resistant layer 3 on the wood board layer 2 located outside the reinforced magnesium substrate 1.

Finally, it should be noted that the above description is only a part of the embodiments of the present application, and is not intended to limit the present application, although the present application has been described in detail with reference to the foregoing embodiments, those skilled in the art may still modify the technical solutions described in the foregoing embodiments, or perform equivalent replacement on some technical features therein, and any modification, equivalent replacement, improvement, and the like made within the spirit and principle of the present application should be included in the protection scope of the present application.

What is claimed is:

1. A reinforced magnesium substrate, comprising the following components in parts by weight: 240-280 parts of magnesium oxide, 172-192 parts of wood fiber, 1.3-3.5 parts of citric acid, 1.3-3.5 parts of phosphoric acid, 1.3-3.5 parts of sodium sulfate, 90-120 parts of magnesium sulfate, and 109-130 parts of water.

2. The reinforced magnesium substrate according to claim 1, wherein a weight ratio of citric acid, phosphoric acid and sodium sulfate is 1:1:1.

3. The reinforced magnesium substrate according to claim 1, wherein the magnesium oxide is 255-265 parts by weight; the magnesium sulfate is 100-110 parts by weight; and the water is 115-125 parts by weight.

4. The reinforced magnesium substrate according to claim 1, wherein the wood fiber has a fiber length of 3 mm-6 mm and a moisture content of 0.5%-10%.

5. The reinforced magnesium substrate according to claim 1, wherein the magnesium oxide is light burned magnesium oxide, and the magnesium sulfate is anhydrous magnesium sulfate.

6. A composite board with a reinforced magnesium substrate, comprising:
a reinforced magnesium substrate configured as a plate core of a composite board, wherein the reinforced magnesium substrate adopts the reinforced magnesium substrate according to claim 1;
wood board layers arranged on two sides of the reinforced magnesium substrate respectively and fixed relative to the reinforced magnesium substrate; and
a wear-resistant layer arranged on at least one wood board layer and relatively fixed with the wood board layer.

7. The composite board with the reinforced magnesium substrate according to claim 6, wherein the composite board further comprises a connecting layer, the connecting layer is between the wood board layer and the reinforced magnesium substrate, and the connecting layer is made of polyurethane adhesive.

8. The composite board with the reinforced magnesium substrate according to claim 6, wherein the composite board further comprises a decorative paper, and the decorative paper is between the wood board layer and the wear-resistant layer.

9. The composite board with the reinforced magnesium substrate according to claim 6, wherein the composite board further comprises a balance paper, the balance paper is on a wood board layer located on an inner side of the reinforced magnesium substrate, and the balance paper faces a ground surface or a wall on which the composite board is laid.

10. The composite board with the reinforced magnesium substrate according to claim 6, wherein the composite board further comprises a cushion layer, and the cushion layer is in contact with the ground or wall on which the composite board is laid.
